(19) United States
(12) Patent Application Publication
(10) Pub. No.: US 2003/0226920 A1
(43) Pub. Date: Dec. 11, 2003

(54) Fine powdered sand gathering system in dry condition

(76) Inventor: Sigeo Yanase, Kisarazu City (JP)

Correspondence Address: Henneman & Saunders, 714 W. Michigan Ave., Three Rivers, MI, 49093, US

(21) Appl. No.: 10/207,398

(22) Filed: Jul. 29, 2002

(30) Foreign Application Priority Data
Jun. 6, 2002 (JP) TOKUGAN2002-16547

(51) Int. Cl. B02C 17/00

(52) U.S. Cl. 241/171

(57) ABSTRACT

The purpose is to provide a dry type fine powder collecting system which enables that, in the crusher and triturator which process materials under dried condition, the fine powder generated during processing is collected efficiently and certainly, and the same washing effect as in wet condition is acquired without needing a large amount of equipment cost, and the quality and processing efficiency of the product is improved, and the work environment is also improved.

To achieve the purpose described as above, the present invention provides a fine powder collection system having a processing space which accommodates, crush or triturate materials, and the system is in the device where materials are crushed or triturated under dried condition in the said processing space. In addition, it is a dry type fine powder collection system wherein a blowing mean which floats the fine powder generated during crushing or triturating by blowing vapor into the processing space, and a suction mean which sucks the fine powder floated by the said blowing mean in the processing space are arranged in the said device.

### TECHNICAL FIELD OF THE INVENTION

The present invention relates to the fine powdered sand gathering system in dry condition which can improve process efficiency and the quality of the product in the fine powder which occurs during the process in the crusher and triturator which deals with raw material with dry type.

### PRIOR ARTS

A triturator to wear away the surface of raw material and a crusher to crush raw material delicately have been used widely from before in the various technological fields, and for example, they have been used abundantly as for the production process of aggregate in the field of architecture and construction.

When crush process and trituration process are done with these devices, although these process are done in dry type, and wet type, there are many cases that generally dry type process is adapted because in the wet type, large quantities of water should be necessary and treating of water after using is difficult.

However, in case of dry type, large quantities of fine powder occurs during the process, hence in and after the process, large quantities of fine powder stirred up in shop floor, and by this, there has been a danger of having a bad influence on a worker's body.

Moreover, there has been problems that the quality of the finished product declined by mixing fine powder in the product and processing efficiency of the crush and trituration decreasing by attaching the fine powder which occurred in the device.

The present invention is invented in consideration of these cases, its purpose is to provide a fine powdered sand gathering system in dry condition that can efficiently and securely collect the fine powder which occurs by crush processing and trituration processing, and a large sum of equipment cost is not necessary, and can get same effect on washing as the wet processing effect, and can improve the quality of the product and processing efficiency and improve working environment in the crusher and triturator which deals with raw material with dry type.

### BRIEF EXPLANATION OF DRAWINGS

FIG. 1 is a front view of the triturator applying the system according to the present invention.

FIG. 2 is a longitudinal sectional view of the triturator applying the system according to the present invention.

FIG. 3 is a plan view of the triturator applying the system according to the present invention.

FIG. 4 is a sectional view at A-A line in FIG. 1.

FIG. 5 is a sectional view at B-B line in FIG. 1.

FIG. 6 is a diagram showing another example of the stay adjustment board.

FIG. 7 is a diagram showing one example of the form of partition member.

FIG. 8 is a diagram showing one example of the form of partition member.

FIG. 9 is a diagram showing the construction of inclined mechanisms.

### DETAILED DESCRIPTION OF THE INVENTION

Hereinafter, preferred embodiments of the fine powdered sand gathering system in dry condition which relates to the present invention is explained with referring to the drawings.

The system which relates to the present invention has the processing space to house, crush and triturate the raw materials, and it is adapted to a device which crushes or triturates the raw material by dry type in the processing space.

As a device that the invention is applicable, a crusher such as Super Thunder (product name: manufactured by Kawasaki Heavy Industries, Ltd.) and a trituration such as a ball mill or a rod mill are exemplified, but the device is not limited to these devices.

Hereinafter, the case that the system concerning to the present invention is applied to the trituration which the inventor invented is mentioned as an example, as described above, the device with which the present invention is applied is not limited to this, but also can be applied to well known and commercial crusher and a trituration.

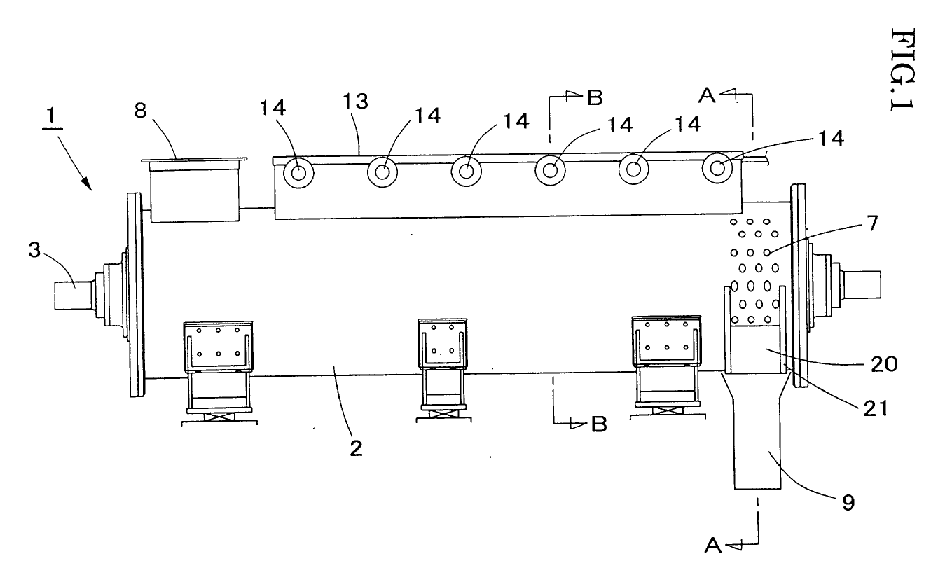

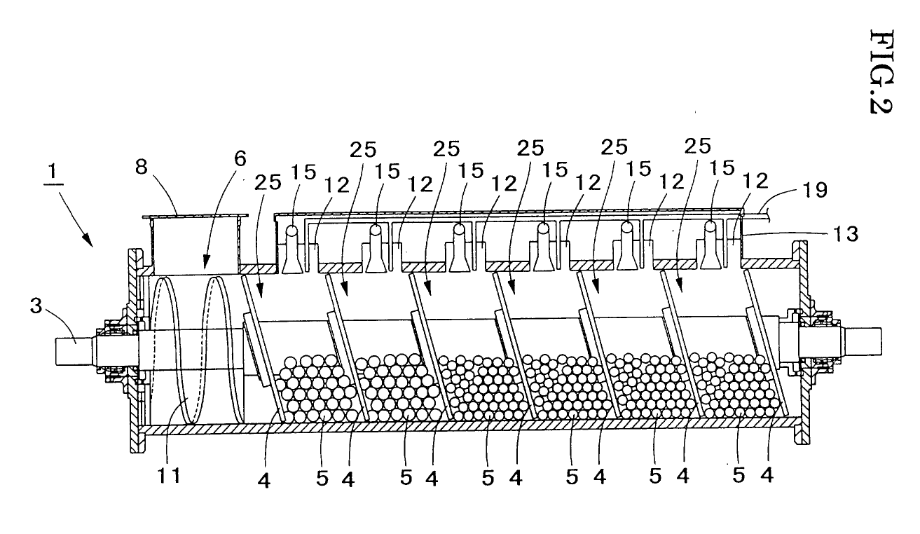

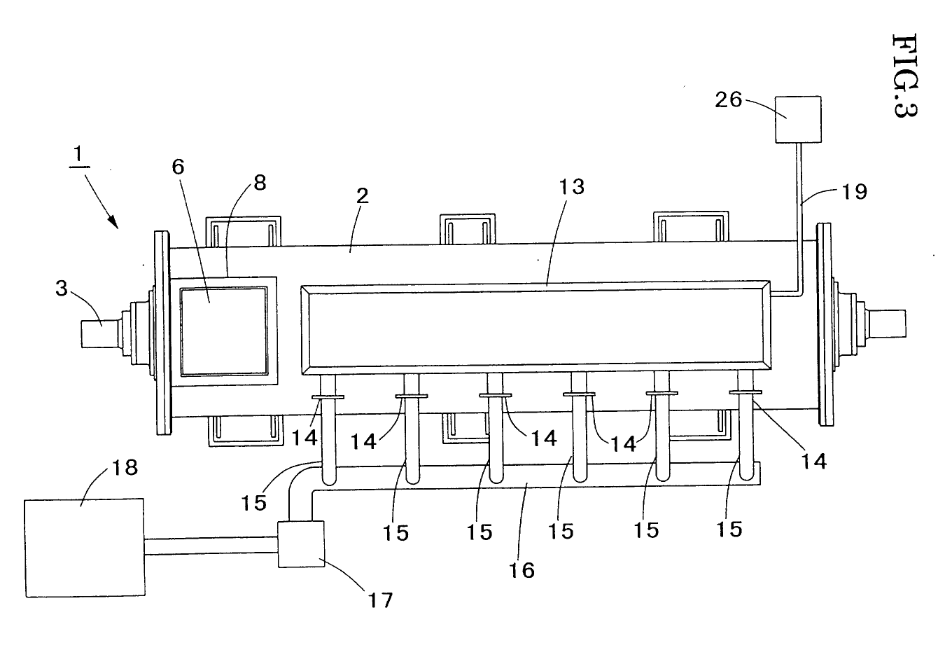

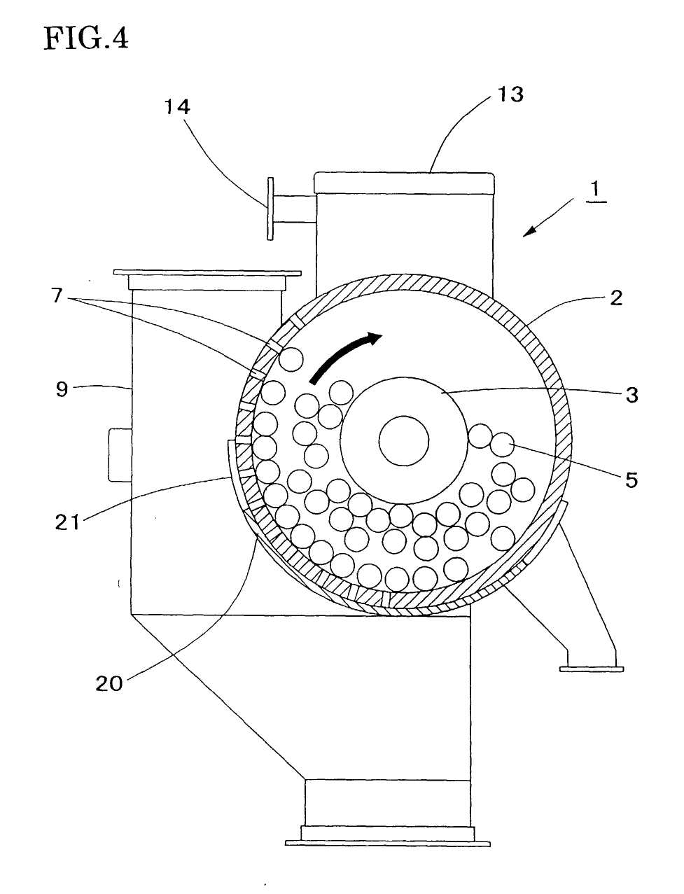

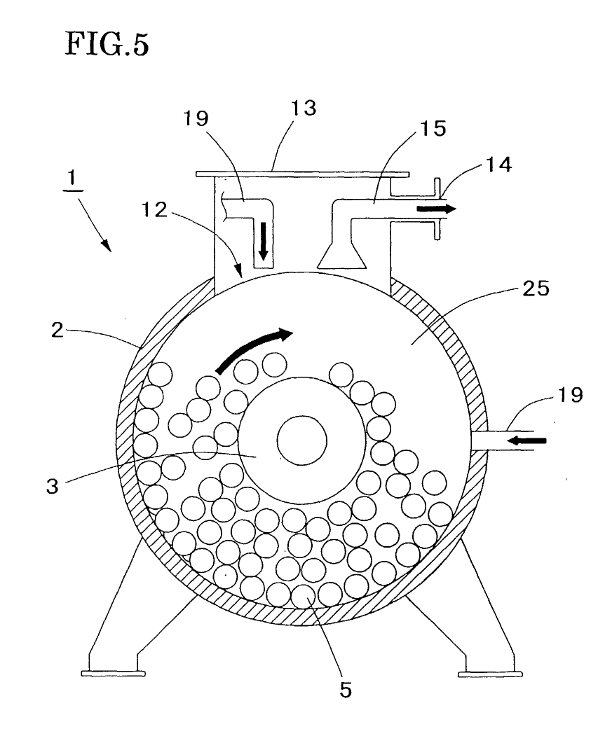

FIG. 1 is a front view of a triturator which relates to the present invention, FIG. 2 is an its longitudinal sectional view, FIG. 3 is an its plan view, FIG. 4 is an A-A line cross section of the FIG. 1 and FIG. 5 is a B-B line cross section of FIG. 1.

A tritulator (1) has a drum body (2), a rotation shaft (3), a partition member (4) and a loading for trituration (5). An inlet port (6) which brings in triturated material (raw material) is set up in one end part of the cylinder-shaped drum body (2), and an outlet port (7) which discharges triturated material after trituration is set up in other end part.

The inlet port (6) is set up largely and opened on surface of the drum body (2), and a hopper (8) for injection the material which is triturated is connected at upper part of the drum body (2).

The outlet ports (7) are constructed from many holes which are formed in one side of peripheral wall of the drum body (2), and as shown in FIG. 4, a discharging hopper (9) is connected as surrounding the holes which composes these outlet ports (7). Also, the discharging hopper (9) is shown the whole only in the FIG. 4, and a part or the whole are omitted in other figures.

Moreover, in other end of the drum body (2) where the outlet port (7) is formed, a stay adjustment board (20) is located along a portion of about one-third of peripheral wall of the drum body (2). The stay adjustment board (20) is supported in the right and left end by a support member (21) located at few distance with the peripheral wall in lower half of the peripheral wall of the drum body (2), and within limits in which the support component (21) is prepared, the stay adjustment board (20) can slide movement up and down in a distance between the support member (21) and peripheral wall of the drum body (2).

Said stay adjustment board (20) which is above-mentioned is arranged to adjust staying time in the drum body (2) inside of the triturated material, and when the stay adjustment board (20) moves to upward, the outlet port (7) in almost half positions of under part comes to be blocked off, the triturated material is discharged from only the outlet ports (7), hence the staying time in the drum body (2) of the triturated material becomes long.

On the other hand, the stay adjustment board (20) is done slide movement down below, the blocked outlet port (7) is opened, the triturated material will come to be discharged also from the outlet port (7) in a lower part position, and the staying time within the drum body (2) of triturated material will become short.

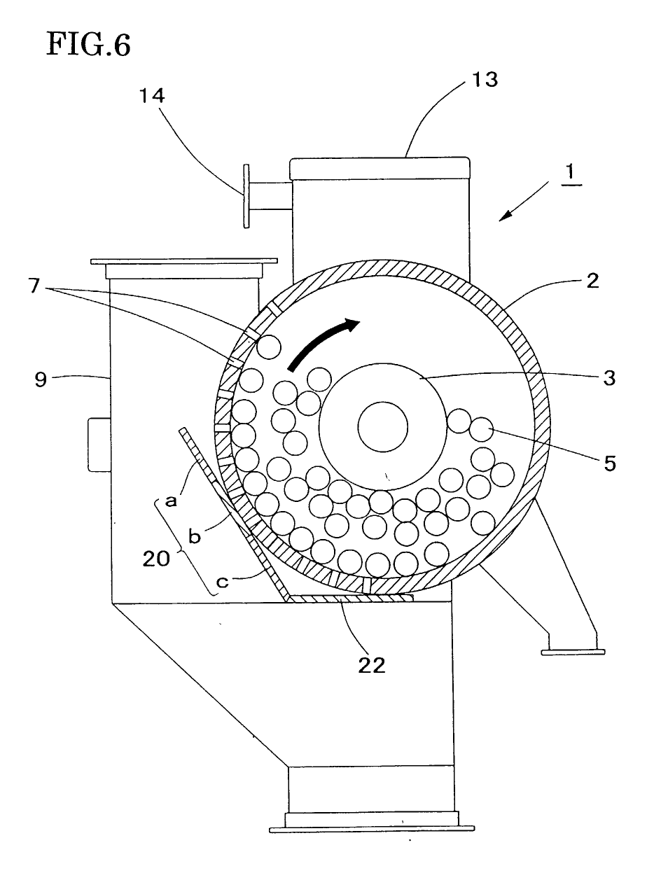

FIG. 6 is an outline figure showing another example of the stay adjustment board (20).

In this example, the stay adjustment board (20) consists of plates (a, b, c) divided into plurality of sheets (three sheets are shown in Figures), and it inclines to a fixed board (22) fixed horizontally with the lower part position of the drum body (2), further it is connected and installed each other.

The stay adjustment board (20) is installed so that the outlet port (7) of the drum body (2) is taken along with a surface of arranged side, and as shown in Figures, the height blocked the outlet port (7) which is in almost lower half position of the drum body (2) as shown, when all the boards are connected.

The stay adjustment board (20) as shown in FIG. 6 can play the role which adjusts staying time within the drum body (2) of the triturated material. That is, if plurality of plates which constitute the stay adjustment board (20) are connected, it will come to be discharged only from the outlet port (7) which is in the position in the lower half is covered, and the triturated material in an upper part position, and staying time within the drum body (2) of then will become long.

On the other hand, if a part or all of plurality of flat plates which consist of the stay adjustment board (20) are removed, the blocked outlet port (7) is opened, the triturated material will come to be discharged also from the outlet port (7) in a lower part position, and staying time within the drum body (2) of the triturated material will become short.

The rotation shaft (3) is arranged so that inside of the drum body (2) may be pierced through the drum body (2) in the direction of axial length, and the end part can rotate by connecting a drive motor (illustration is abbreviated).

In addition, the rotation shaft (3) may be solid, and may supply air etc. in a processing space (25) through the inside of the shaft as hollow.

The partition member (4) is attached in the rotation shaft (3) with inclined angle to the rotation shaft (3). The partition member (4) divides the inside of the drum body (2), and forms plurality of processing spaces (25) which communicates mutually in the drum body (2). Although the processing space (25) communicates each other, a size of the communicating part is that the loading for trituration (5) does not pass.

The partition member (4) has a conducting aperture (10) which passes the triturated material, and the conducting aperture (10) is equivalent to the above-mentioned communicating part of each processing space (25). The size of the conducting aperture (10) is made a size that passes only the triturated material until it becomes under the fixed dimension. In addition, the partition member (4) may be platy and may be mesh.

Although the number of the partition member (4) is not particularly limited, and one sheet is available, but it is desirable to arange the partition member (4) in the direction of axial length of the rotation shaft (3), to arrange distance mutually, and to prepare plurality of sheets as shown in Figures, and the processing space (25) is formed among the partition member (4) in this case, respectively.

In the case of arranging, the partition member (4) in the direction of shaft length of the rotation shaft (3) and arranging a distance mutually so as to arrange plurality of sheets, a size of the conducting aperture (10) arranged in the partition member (4), as described above, it considers as a size which passes only the triturated material which has under a predetermined size, and it is desirable that the predetermined size is reduced gradually from the partition member (4) of upstream side of the drum body (2) (end side) to the partition member (4) of down stream side (other end side).

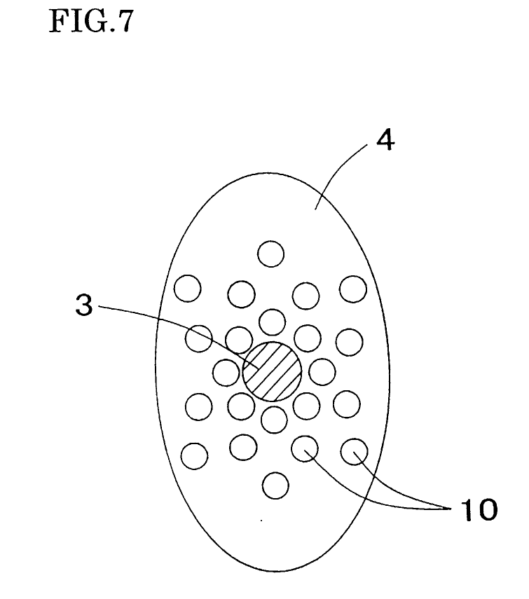

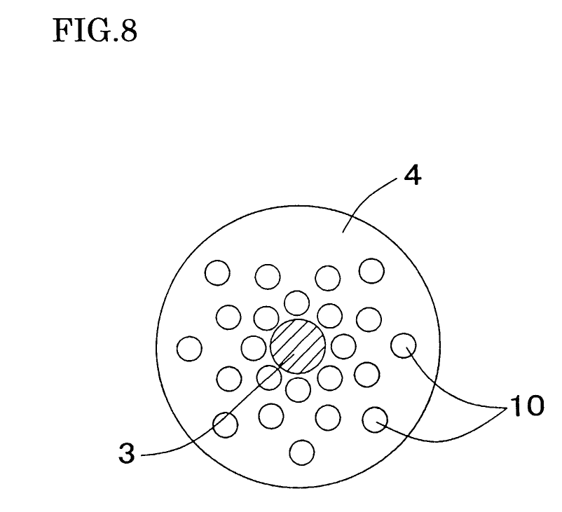

Although a form of the partition member (4) is not particularly limited, for example, it is desirable that to constitute as an ellipse form so that the circumferential whole edge may close inner surface of the drum body (2) as shown in FIG. 7, and it is also desirable as circular as shown in FIG. 8. Moreover, a form of the conducting aperture (10) may be circular form, elliptical shape and arietiform such as a quadrangle and a triangle as shown in Figures.

A screw (11) is arranged in one end of the rotation shaft (3) in bottom of the inlet port (6), and it can pass the triturated material which is dropped from the inlet port (6) to the direction of other end parts due by the rotation of the rotation shaft (3). In addition, the screw (11) is not necessarily required and can also be considered as the composition which prepares the first processing space (25) directly under the inlet port (6), without preparing the screw (11). The loading for trituration (5) (in following, it is described as the loading (5)) is charged plurality in inside of each processing space (25). The loading (5) consists of a metal ball etc., and the triturated material is triturated by colliding with triturated material taken in the processing space (25).

An opening (12) is formed in the upper part of each processing space (25) of the drum body (2), respectively, and a box shape part (13) which covers the opening (12) altogether is further formed in the upper part of these openings (12).

The box shape part (13) communicates with the exterior by a side opening (14) which is opened at the side, and the side opening (14) is arranged in the position corresponding to each processing space (25), respectively.

A suction pipe (15) is inserted in each side opening (14), respectively, and a tip of these suction pipe (15) enters from the opening (12), and is arranged in each processing space (25) within the drum body (2). The tip of the suction pipe (15) is broadened in a shape of a circular cone, and can suck in efficiently the fine powder generated in the processing space (25). Moreover, a base end part of each suction pipe (15) is connected to one suction path (16), and the suction path (16) is connected to a dust catcher (18) which consists of bag filters through a suction pump (17).

Moreover, a box shape part (13) is arranged on a air supply pipe (19), and the air supply pipe (19) is branched off in halfway, and the end of each divergence is included from the opening (12), and arranged to inside of each processing space (25) of inside of the drum body (2).

The base end part of the air supply pipe (19) is taken out from the box shape part (13) side to the outside, and connected to a ventilator (26).

As this, the tips of the suction pipe (15) and the air supply pipe (19) are inserted into each of each processing space (25) inside of the drum body (2), and by this, it can absorb and supply independently of air inside of the each processing space (25).

Further, in the present invention, the air supply pipe (19) can be fixed in not only the top of the drum body (2) but also the side part as the FIG. 5.

Moreover, in the present invention, when a dynamo which supplies electric power for driving to the triturator is connected, it is desirable to introduce exhaust heat generated with the dynamo in the processing space (25).

This can be attained by the air supplied to the air supply pipe (19) by exhaust heat which occurred in the generator is warmed up, and supplying warmth from the air supply pipe (19) to the inside of processing space (25).

Thus, the inside of the processing space (25) can be dried by using exhaust heat and supplying warmth in the processing space (25). Therefore, the fine powder generated in the processing space (25) attaches to the loading (5), attaching to triturated material again is lost, and processing efficiency can be raised.

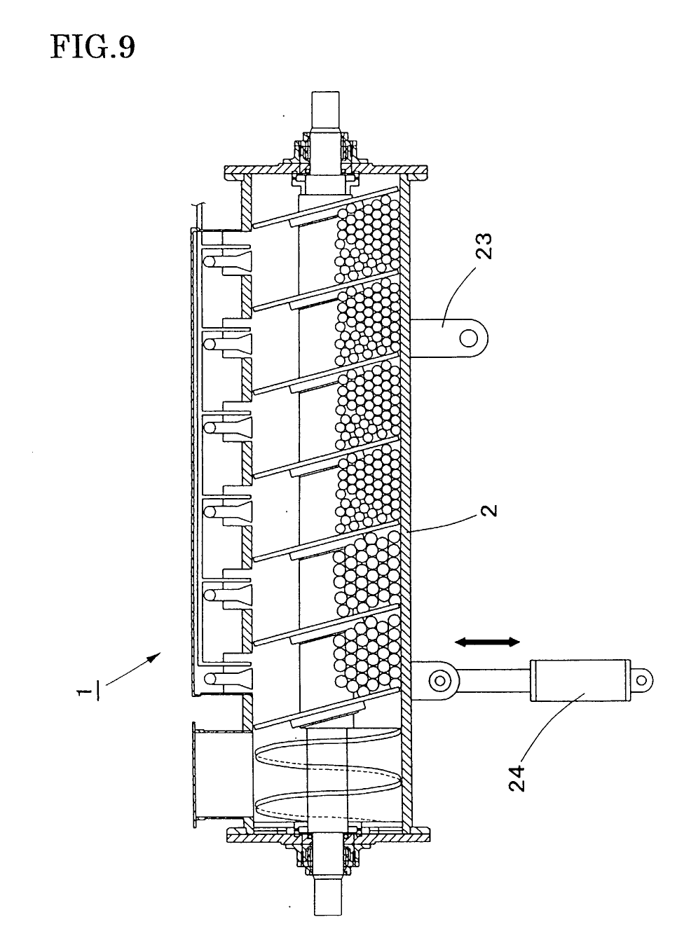

Moreover, it is desirable to locate an inclination mechanism for making the other end part of the drum body (2) into a low position rather than an end part in the drum body (2). FIG. 9 shows the construction of the inclination mechanism. The inclination mechanism is constituted using legs attached under the drum body (2), and consist of a fulcrum leg (23) attached in the other end part (downstream side) of the drum body (2), and a telescopic leg (24) attached in the one end part (upstream side). The fulcrum leg (23) is a portion used as a fulcrum, when the drum body (2) inclines, and the undersurface is made into the circular side. The telescopic leg (24) consists of flexible mechanisms, such as an oil pressure cylinder, and becomes as the same length as the fulcrum leg (23) in the state where it was shrunk.

Therefore, if the telescopic leg (24) is shrunk, the drum body (2) will become parallel to the ground, and if it elongates, the drum body (2) comes to incline downward towards to other ends part from one end part. Moreover, inclination of the drum body (2) can be adjusted by adjusting the degree of extension.

Further, the telescopic leg (24) is arranged in the end part (downstream side) of the drum body (2), and the fulcrum leg (23) is arranged in one end part (upper stream side), and the drum body (2) is inclined downward from one end part to other end parts by making the fulcrum leg (23) shorten the telescopic leg (24).

By arranging such the inclination mechanism, staying time within the drum body (2) of triturated material can be adjusted, and it becomes possible to easily adjust quality, such as a particle size of the aggregate obtained as the finished product.

Moreover, it is possible to incline upward the drum body (2) from one end part to other end part by expansion and contraction of the telescopic leg (24), and in this case, it is possible to arrange the staying time within the drum body (2) of triturated material for a long time.

Hereafter, the operation of the system according to the present invention is explained.

First, the triturated material is thrown into the drum body (2) from the hopper for throwing (8). Then, by rotation of the screw (11) prepared in one end part of the rotation shaft (3), the triturated material is sent in the direction of the other end part (in the example of illustration is right), and enter in the first processing space (25) passing through the conducting aperture (10) arranged in the partition member (4) which is arranged at the first position counted from upstream side.

Here, since the partition member (4) inclines to the rotation shaft (3), the partition member (4) repeats quickly anteversion state and retroversion state in the direction of axial length of the rotation shaft (3), with rotation of the rotation shaft (3). Thereby, while the triturated material and the loading (5) fall after they have been strongly floated up, and the floating-falling movement is repeated, they pump quickly in the direction of axial length of the rotation shaft (3). Thereby, the triturated material and the loading (5) collide uniformly, and they are triturate-processed in the first processing space (25).

If the triturate processing has been done in the processing space (25) to a certain degree, the triturated material becomes the size which can pass the conducting aperture (10) arranged in the second partition member (4) counted from upstream side, and pass through the conducting aperture (10), then enter in the second processing space (25).

And, when the same processing as in the first processing space is performed in the second processing space (25), and when the triturated material is triturated to a certain degree, the triturated material becomes the size which can pass the conducting aperture (10) arranged in the third partition member (4) counted from upstream side, and pass through the conducting aperture (10), then enters in the third processing space (25).

Thus, the triturated material is gradually approaching the desired particle diameter by passing through in order two or more processing spaces (25) arranged in the drum body (2), and the triturated material which became the desired particle diameter is discharged through the outlet ports (7) prepared in the right end part of a drum body (2) to the discharging hopper (9).

The triturated material which was discharged can be used, for example, as an aggregate for concretes (RC-20).

Thus, when the triturated material which was thrown in the drum body (2) undergoes triturate processing in each processing space (25), a lot of fine powder is generated in each processing space (25).

Then, in the present invention, during the triturate processing described as above, air is blown off downward from the suction pipe (15) in each processing space (25), and the fine powder deposited in each processing space (25) is floated by this, and sucking power is simultaneously generated at the tip of the air supply pipe (19), and the fine powder which was floated in each processing space (25) is sucked and collected.

Thereby, in spite of being in dried condition, the washing effect of the triturated material same as in wet condition is acquired, and as shown in the example described hereinafter, this enables that the quality of finally obtained product, such as aggregate, is greatly improved.

The fine powder which was sucked by the suction pipe (15) is of particle diameter, for example, 0 to 1 mm, and 0 to 2 mm, and the fine powder sucked into the suction pipe (15) in each processing space (25) is passed to a bag filter (18) by way of suction passage (16) and then collected there.

Thus, the fine powder collected in this way can be reused as a soil improvement material and remblai.

### EXAMPLES

Hereafter, the effect of the present invention is defined by showing examples and comparative examples of the system according to the present invention. However, the present invention is not limited at all by the following examples.

### Example

Employing concrete husks as raw material, triturate processing was performed using a triturator which consists of the composition shown in FIG. 1 to FIG. 5, and an aggregate for concretes (RC-20) was obtained as a finished product.

### Comparative Example

In the triturator used in the example, the suction pipe (15) and the air supply pipe (19) were removed, and triturate processing same as the example was performed, and an aggregate for concretes (RC-20) was obtained as a finished product.

The processing efficiency of the triturator used in the example and comparative example, and also the acquired characteristics of the aggregate for concretes are shown in Table 1.

TABLE 1

| | Quality | | Comparative |
|---|---|---|---|
| Items | Standard | Example | Example |
| Processing Efficiency | — | 30 | 20 |
| (ton/hr) | | | |
| Density (in absolute dry | more than | 2.62 | 2.52 |
| condition) (g/cm³) | 2.5 | | |
| Percentage of Water | less than | 1.55 | 2.35 |
| Absorption (%) | 3.0 | | |
| Percentage | more than | 60.1 | 56.5 |
| of Accomplishment (%) | 55 | | |
| Quantity lost by | less than | 0.3 | 3.5 |
| washing test (%) | 1.0 | | |

As shown in Table 1, compared with the comparative example, processing efficiency of the example which applied the fine powdered sand gathering system in dry condition according to the present invention was improved by about 1.5 times. Moreover, the aggregate obtained in the example was superior to the aggregate obtained by the comparative example in all JIS quality-standards items of density (in absolute dry condition), percentage of water absorption, percentage of accomplishment, quantity lost by washing test. Especially, in the comparative example, the quantity lost by washing test was not able to fulfill the quality standards, but the lost quantity by washing test in the example is one tenth of that of the comparative example, and was fully able to fill the quality standards.

From this result, when the system according to the present invention is applied, it is possible that by directly suctioning and collecting the fine powder generated during processing from processing space, the processing effect is drastically improved by preventing attachment of the generated fine powder on the ball and triturated material, and the same washing effect of triturated material as in wet condition is acquired by the suction, and the quality of finished product is improved by preventing attachment and mixing of the generated fine powder to the product.

Effects of the Invention

As described as above, according to the invention in claim 1, in the crusher and triturator which process materials in dried condition, a certain and efficient collection of fine powder generated by crush processing or triturate processing can be performed, and without needing a large amount of equipment cost, work environment can be improved by preventing generation of coarse particulates, and in spite of being dried condition, the same washing effect of triturated material as in wet condition is acquired, therefore the quality of products and processing efficiency can be improved.

Moreover, according to the invention in claim 2, most of the fine powder which was sucked by the suction mean is certainly collected, and it can be reused as a soil improvement material and remblai.

Moreover, according to the invention in claim 3 and 4, it becomes possible to collect efficiently the fine powder generated in the crusher and triturator which have two or more processing spaces.

According to the invention in claim 5 to 8, a triturator which has very high triturating efficiency can be obtained.

According to the invention in claim 9 to 16, by effective utilization of exhaust heat, processing efficiency of triturating can be improved.

According to the invention in claim 17 to 24, while floating the fine powder in the processing space, it can be dried simultaneously, and this is very efficient.

According to the invention in claim 25 to 32, it becomes possible to adjust the stay time of the triturated material in the drum body, and to adjust the quality of the finished product easily.

What is claimed is:

1. A fine powdered sand gathering system in dry condition which has a processing space to house, crush or triturate the raw material and in a device to crush or triturate raw material under dried condition in a processing space, wherein: in said device, a blowing mean by blowing air in said processing space to float fine powder caused in crush and trituration and aspiration mean to suck in fine powder floated in the processing space by said blowing mean are arranged.

2 A fine powdered sand gathering system in dry condition described in claim 1, wherein: said aspiration mean is connected to a bag filter.

3 A fine powdered sand gathering system in dry condition described in claim 1, wherein: said processing space is divided in plurality of spaces which communicate respectively, said blowing mean and said aspiration mean are arranged to each space.

4 A fine powdered sand gathering system in dry condition described in claim 2, wherein: said processing space is divided in plurality of spaces which communicate respectively, said blowing mean and said aspiration mean are arranged to each space.

5 A fine powdered sand gathering system in dry condition described from claim 1, wherein: said device comprises of a drum body where an inlet port to bring in raw material is arranged in one end part, and an outlet port to discharge triturated material after processing in other end part is arranged, a rotation shaft which pierces inside of the drum body in the direction of axial length of the drum body, a partition member which divides the inside of the drum body and forms plurality of processing spaces which communicates mutually in the drum body, and loading for trituration of necessary number which is loaded in said processing space.

6 A fine powdered sand gathering system in dry condition described from claim 2, wherein: said device comprises of a drum body where an inlet port to bring in raw material is arranged in one end part, and an outlet port to discharge triturated material after processing in other end part is arranged, a rotation shaft which pierces inside of the drum body in the direction of axial length of the drum body, a partition member which divides the inside of the drum body and forms plurality of processing spaces which communicates mutually in the drum body, and loading for trituration of necessary number which is loaded in said processing space.

7 A fine powdered sand gathering system in dry condition described from claim 3, wherein: said device comprises of a drum body where an inlet port to bring in raw material is arranged in one end part, and an outlet port to discharge triturated material after processing in other end part is arranged, a rotation shaft which pierces inside of the drum body in the direction of axial length of the drum body, a partition member which divides the inside of the drum body and forms plurality of processing spaces which communicates mutually in the drum body, and loading for trituration of necessary number which is loaded in said processing space.

8 A fine powdered sand gathering system in dry condition described from claim 4, wherein: said device comprises of a drum body where an inlet port to bring in raw material is arranged in one end part, and an outlet port to discharge triturated material after processing in other end part is arranged, a rotation shaft which pierces inside of the drum body in the direction of axial length of the drum body, a partition member which divides the inside of the drum body and forms plurality of processing spaces which communicates mutually in the drum body, and loading for trituration of necessary number which is loaded in said processing space.

9 A fine powdered sand gathering system in dry condition described in claim 1, wherein: exhaust heat of a dynamo which supplies electric power for driving to said device is introduced in said processing space.

10 A fine powdered sand gathering system in dry condition described in claim 2, wherein: exhaust heat of a dynamo which supplies electric power for driving to said device is introduced in said processing space.

11 A fine powdered sand gathering system in dry condition described in claim 3, wherein: exhaust heat of a dynamo which supplies electric power for driving to said device is introduced in said processing space.

12 A fine powdered sand gathering system in dry condition described in claim 4, wherein: exhaust heat of a dynamo which supplies electric power for driving to said device is introduced in said processing space.

13 A fine powdered sand gathering system in dry condition described in claim 5, wherein: exhaust heat of a dynamo which supplies electric power for driving to said device is introduced in said processing space.

14 A fine powdered sand gathering system in dry condition described in claim 6, wherein: exhaust heat of a dynamo which supplies electric power for driving to said device is introduced in said processing space.

15 A fine powdered sand gathering system in dry condition described in claim 7, wherein: exhaust heat of a dynamo which supplies electric power for driving to said device is introduced in said processing space.

16 A fine powdered sand gathering system in dry condition described in claim 8, wherein: exhaust heat of a dynamo which supplies electric power for driving to said device is introduced in said processing space.

17 A fine powdered sand gathering system in dry condition described in claim 9, wherein: said exhaust heat is introduced in the processing space by said blowing mean.

18 A fine powdered sand gathering system in dry condition described in claim 10, wherein: said exhaust heat is introduced in the processing space by said blowing mean.

19 A fine powdered sand gathering system in dry condition described in claim 11, wherein: said exhaust heat is introduced in the processing space by said blowing mean.

20 A fine powdered sand gathering system in dry condition described in claim 12, wherein: said exhaust heat is introduced in the processing space by said blowing mean.

21 A fine powdered sand gathering system in dry condition described in claim 13, wherein: said exhaust heat is introduced in the processing space by said blowing mean.

22 A fine powdered sand gathering system in dry condition described in claim 14, wherein: said exhaust heat is introduced in the processing space by said blowing mean.

23 A fine powdered sand gathering system in dry condition described in claim 15, wherein: said exhaust heat is introduced in the processing space by said blowing mean.

24 A fine powdered sand gathering system in dry condition described in claim 16, wherein: said exhaust heat is introduced in the processing space by said blowing mean.

25 A fine powdered sand gathering system in dry condition described in claim 5, wherein: a stay adjustment board (20) which can block a part of said plurality of outlet ports is arranged.

26 A fine powdered sand gathering system in dry condition described in claim 6, wherein: a stay adjustment board (20) which can block a part of said plurality of outlet ports is arranged.

27 A fine powdered sand gathering system in dry condition described in claim 7, wherein: a stay adjustment board (20) which can block a part of said plurality of outlet ports is arranged.

28 A fine powdered sand gathering system in dry condition described in claim 8, wherein: a stay adjustment board (20) which can block a part of said plurality of outlet ports is arranged.

29 A fine powdered sand gathering system in dry condition described in claim 5, wherein: in said drum body, an inclination mechanism so that an other end part of the drum body is arranged lower position than an end part.

30 A fine powdered sand gathering system in dry condition described in claim 6, wherein: in said drum body, an inclination mechanism so that an other end part of the drum body is arranged lower position than an end part.

31 A fine powdered sand gathering system in dry condition described in claim 7, wherein: in said drum body, can inclination mechanism so that an other end part of the drum body is arranged lower position than an end part. 32 A fine powdered sand gathering system in dry condition described in claim 8, wherein: in said drum body, an inclination mechanism so that an other end part of the drum body is arranged lower position than an end part.
